(19) United States
(12) Patent Application Publication
(10) Pub. No.: US 2002/0017779 A1
(43) Pub. Date: Feb. 14, 2002

(54) Airbag structure

(76) Inventors: Michael W. Gilpatrick, Chesnee, SC (US); Charles E. Willbanks, Spartanburg, SC (US)

Correspondence Address: Milliken & Company, P.O. Box 1927, Spartanburg, SC, 29304, US

(21) Appl. No.: 09/862,816

(22) Filed: May 22, 2001

Related U.S. Application Data
(63) Continuation-in-part of application No. 09/167,060, filed on Oct. 6, 1998.

(51) Int. Cl. B60R 21/16

(52) U.S. Cl. 280/743.1

(57) ABSTRACT

A strong lightweight airbag cushion for deployment in opposing relation to a vehicle occupant and the method of making same. The cushion is formed from a body of wound yarn. The body includes an interior, a face portion for contact with the occupant and a rear portion including an inlet port for the introduction of an inflation medium. The body is formed by the continuous winding of yarn around a mandrel such that the yarn is spread across the face and is disposed preferentially across the back in the area surrounding the inlet port. This is accomplished by shifting or shogging the yarn supplying mechanism relative to the cushion mandrel. The body may also include at least one film layer and at least one coating layer.

### CROSS REFERENCE TO RELATED APPLICATIONS

This application is a continuation-inpart of and claims priority to U. S. Patent Application Serial Number 09/167,060 filed October 6, 1998, and hereby incorporated by reference.

### FIELD OF THE INVENTION

The present invention relates to inflatable protective cushions, and more specifically relates to a cushion formed by the highly efficient continuous winding of yarn. The cushion is particularly useful in the frontal or side protection of occupants in a transportation vehicle, such as an automotive vehicle, railroad, car, airplane or the like. A process for forming the cushion and an optimum shape for the cushion according to the present invention are also provided.

### BACKGROUND

Inflatable protective cushions used in passenger vehicles are a component of relatively complex passive restraint systems. The main elements of these systems are: an impact sensing system, an ignition system, a propellant material, an attachment device, a system enclosure, and an inflatable protective cushion. Upon sensing an impact, the propellant is ignited causing an explosive release of gases filling the cushion to a deployed state which can absorb the impact of the forward movement of a body and dissipate its energy by means of rapid venting of the gas. The entire sequence of events occurs within about 30 milliseconds. In the un-deployed state, the cushion is most commonly stored in or near the steering column, the dashboard, in a door panel, or in the back of a front seat placing the cushion in close proximity to the person or object it is to protect.

Inflatable cushion systems commonly referred to as airbag systems have been used in the past to protect both the operator of the vehicle and passengers. Systems for the protection of the vehicle operator have typically been mounted in the steering column of the vehicle and have utilized cushion constructions directly deployable towards the driver. These driver-side cushions are typically of a relatively simple sewn configuration. Typically, traditional driver's side inflatable cushions have been formed by sewing together two circular pieces of coated fabric made of nylon or polyester yarn.

Although such sewn products have generally performed quite adequately, they nonetheless have some inherent limitations. First, the sewn seam is generally applied or at leart inspected manually. As will be appreciated, this is a relatively time consuming process which tends to increase manufacturing costs. Second, circular and elliptical cushions formed by sewing around the perimeter are prone to wrinkles which may result in high and low stress concentrations thereby reducing the maximum inflation pressure which can be maintained at the seam. Third, the introduction of a sewn seam necessarily gives rise to small openings for the sewing threads. These openings tend to act as an escape path for the inflation gases within the airbag which may lead to seam slippage or so called “combing” of the seam thereby giving rise to a potential mechanism for failure. Fourth, even after the two disk shaped components are sewn together, the area surrounding the gas introduction port (i.e. the mouth) must generally be reinforced with additional layers of fabric referred to as doublers so as to control the large forces applied in this area during an inflation event. As will be appreciated, the addition of these doublers gives rise to additional manual processing and the need for additional fabric. Finally, the use of substantially circular shapes results in substantial material waste during manufacturing due to the inherent inability of the manufacturer to cut disk patterns in close- packed spacing arrangement.

Various alternative sewn constructions have been proposed such as those disclosed in U.S. Pat. Nos. 5,482,317 to Nelsen et al; 5,520,416 to Bishop; 5,454,594 to Krickl; 5,423,273 to Hawthorn et al; 5,316,337 to Yamaji et al; 5,310,216 to Wehner et al; 5,090,729 to Watanabe; 5,087,071 to Wallner et al.; 4,944,529 to Buckhaus; and 3,792,873 to Buchner (all incorporated herein by reference). However, these constructions each rely on some seaming of precut fabric panels and thus exhibit some if not all of the limitations outlined above.

The manufacture of airbag cushions by means of winding yarns and tape-like materials around a mandrel has been proposed in several publications including Japan Kokai Patent document 3-227751 in the name of Kanuma and Japan Kokai Patent document 3-276845 in the name of Ogami et al. (both incorporated herein by reference).

While these referenced publications recognize many of the limitations inherent in traditional sewn airbags, and have broadly proposed the use of winding technology as a means to avoid those limitations, they nonetheless fail to provide a highly efficient practice for the proper distribution of yarn. Rather, the prior art in this area has relied generally upon the winding of broad, tape like structures or of a relatively large number of parallel yarns to achieve the substantially complete coverage of the cushion surface area. The prior art also fails to teach the ability to preferentially distribute yarns in the area surrounding the inlet opening by shogging so as to provide additional support in this area thereby substantially reducing or eliminating the need for the application of an additional reinforcement in this region.

The airbag according to the present invention is formed from yarn which is substantially evenly distributed across the face of the cushion thereby avoiding the accumulation of yarn and the ultimate development of a nodule of undue thickness at the center of the cushion where impact with an occupant is likely to occur. In addition, the yarn is disposed in such a manner as to avoid the build-up of a thickened ring of yarn adiacent the inflation opening. Instead, a ring of enhanced thickness is built up at a predetermined distance away from the inflation opening thereby enhancing the strength of the cushion at the very location where reinforcement is generally required. The airbag according to the present invention thus provides a useful advancement over the present art.

### SUMMARY OF THE INVENTION

In view of the foregoing, it is a general object of at the present invention to provide an easily manufactured airbag cushion.

It is a more particular object of the invention to provide an airbag cushion formed by the winding of yarn about a removable mandrel such that the yarn is substantially evenly distributed across the face of the cushion.

It is a further object of the present invention to provide an airbag cushion formed by the winding of yarn about a removable mandrel such that the yarn is disposed preferentially across the back of the cushion in the area surrounding the inlet port so as to form a localized region of enhanced thickness at a predetermined distance away from the inlet port to provide additional strength in that region surrounding and adjacent the inlet port.

It is a further potential object of the present invention to provide an airbag cushion formed by the winding of yarn about a removable rotating mandrel wherein the cushion includes a flexible permeability blocking layer of material holding the yarn in place.

In accordance with at least one embodiment, it is an object of the present invention to provide a seamless airbag cushion.

In accordance with at least one embodiment, it is an object of the present invention to provide a tethered airbag cushion.

An additional object of the invention is to provide a low cost inflatable protective cushion of simple and structurally efficient design with a shape and construction that optimizes the cushion's ability to withstand inflation pressure and impact when deployed.

It is a preferred feature of the present invention to provide an airbag cushion formed by the winding of a yarn in a continuous fashion around a generally spheroidal rotating mandrel while systematically shifting or shogging the angle of placement of the yarn with respect to the axis of rotation of the mandrel about a point near the mouth of the bag structure being formed such that a localized region of enhanced thickness is formed around the mouth opening a pre-determined distance therefrom.

It is yet a further potentially preferred feature of the present invention to provide an airbag cushion formed by the winding of a yarn in a continuous fashion around a generally spheroidal rotating mandrel having a shape substantially similar to the desired shape of the finished cushion wherein the ratio of the depth of the cushion to its equatorial diameter is about 0.5 to 0.7.

Another object of the present invention is to provide an airbag cushion having a film layer, an adhesive layer, and a yarn layer.

Still another object of the present invention is to provide an airbag cushion having a blocking preventing layer, a film layer, a yarn layer, and an adhesive layer.

A further object of the present invention is to provide an improved airbag module and/or airbag system incorporating the wound airbag cushion of the present invention.

Another object of the present invention is an airbag cushion comprising a film layer, an adhesive layer, a yarn layer and at least one tether joined to opposing inner surfaces thereof.

In accordance with another aspect of the present invention, there is provided a method of forming a wound airbag cushion including the steps of wrapping a mandrel with a film, coating the film with an adhesive, and winding yarn about the coated film.

Another object of the present invention is to provide a method of forming an airbag cushion including the steps of wrapping a film material about an inflatable mandrel, winding yarn about the film, and coating the wound yarn with an adhesive.

Still another object of the present invention is to provide a method of forming an airbag cushion including the steps of wrapping a removable mandrel with a film, winding yarn about the film, coating the yarn with an adhesive, curing the adhesive to form a bag precursor, removing the bag precursor from the mandrel, inverting it, placing it back on the mandrel, coating the exposed film surface with an anti-blocking and/or burn-resistant material, curing the material, and removing the airbag cushion from the mandrel.

The above object, further including the steps of creating at least one vent hole therein, and adding a heat shield thereto.

The above object further includes the steps of adding at least one tether or diffuser thereto.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the written description and claims as well as the appended drawings.

It is to be understood that both the foregoing general description and the following detailed description are exemplary and explanatory only and are not restrictive of the invention, as claimed.

### BRIEF DESCRIPTION OF THE DRAWINGS

The accompanying drawings which are incorporated in and constitute a part of this specification, serve to illustrate several preferred embodiments and practices according to the present invention and together with the description, serve to explain the principles of the invention wherein:

FIG. 1A is a cutaway view of an inflatable cushion according to the present invention and inflation module housed within the steering column of a vehicle.

FIG. 1B illustrates a cutaway view of an inflatable cushion according to the present invention in deployment between a passenger and the steering column.

FIG. 2 illustrates the yarn winding operation for forming the airbag according to the present invention.

FIGS. 3-5 are plan views of the airbag winding operation carried out according to the potentially preferred practice of the present invention.

FIGS. 6A and 6B are, respectively, elevation views of the rear and front of an airbag cushion formed according to the potentially preferred practice of the present invention.

FIG. 7 is a graphical view showing the actual variation of the yarn density adjacent the hub opening of the airbag for the prior art and the instant invention.

FIGS. 8-12 are, respectively, cross-section representations of the structure of wound airbag cushions in accordance with several different embodiments of the present invention.

FIGS. 13-18 are cross-section illustrations of respective airbag cushions in accordance with several alternative embodiments of the present invention.

### DESCRIPTION OF PREFERRED EMBODIMENTS

Reference will now be made in detail to potentially preferred embodiments and practices. It is, however, to be understood that reference to any such embodiments and practices is in no way intended to limit the invention thereto. On the contrary, it is intended by the applicants to cover all alternatives, modifications and equivalents as may be included within the spirit and scope of the invention as defined by the appended claims.

Airbags may be produced from a number of different materials using a multiplicity of techniques. However, commercially acceptable airbags have heretofore typically been formed, at least in part, from some type of woven textile material. By way of example only and not limitation, such textile materials are disclosed in U.S. Pat. No. 5,503,197 to Bower et al.; U.S. Pat. No. 5,477,890 to Krummheuer et al.; U.S. Pat. No. 5,277,230 to Sollars, Jr.; U.S. Pat. No. 5,259,645 to Hirabayashi, et al.; U.S. Pat. No. 5,110,666 to Menzel et al.; U.S. Pat. No. 5,093,163 to Krummheuer et al.; U.S. Pat. No. 5,073,418 to Thornton et al.; U.S. Pat. No. 4,921,735 to Bloch; and U.S. Pat. No. 3,814,141 to Iribe et al; (all incorporated herein by reference).

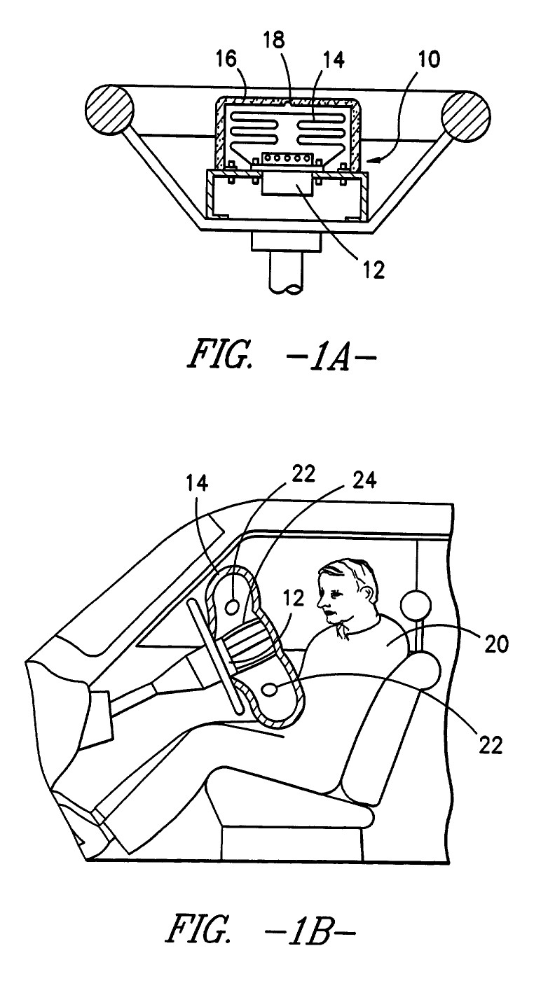

A typical airbag deployment system 10 for use in opposing relation to the driver of a vehicle is illustrated in Fig. 1A. In general, similar equipment is used in passenger and side protection devices, although the geometry of the components therein may vary. The airbag deployment system 10 generally comprises an inflator 12, an inflatable cushion 14 which includes a mouth portion surrounding the inflator 12 thereby permitting the cushion to be inflated by gas released from the inflator during a collision event. The cushion 14 and inflator 12 are typically housed beneath a frangible cover 16 which breaks open along a notch 18 of reduced thickness during the deployment event. As illustrated in FIG. 1B, upon deployment the cushion 14 is in a position to receive a vehicle occupant 20. As will be appreciated, the kinetic energy of the occupant 20 is dissipated by the collapse of the cushion 14 as gas is released either through inherent permeability of the material forming the cushion 14 and/or through internal pressure sensitive vents 22. The cushion 14 may further include shape controlling tethers 24 which require the cushion to expand to a pre-determined desirable geometry upon inflation.

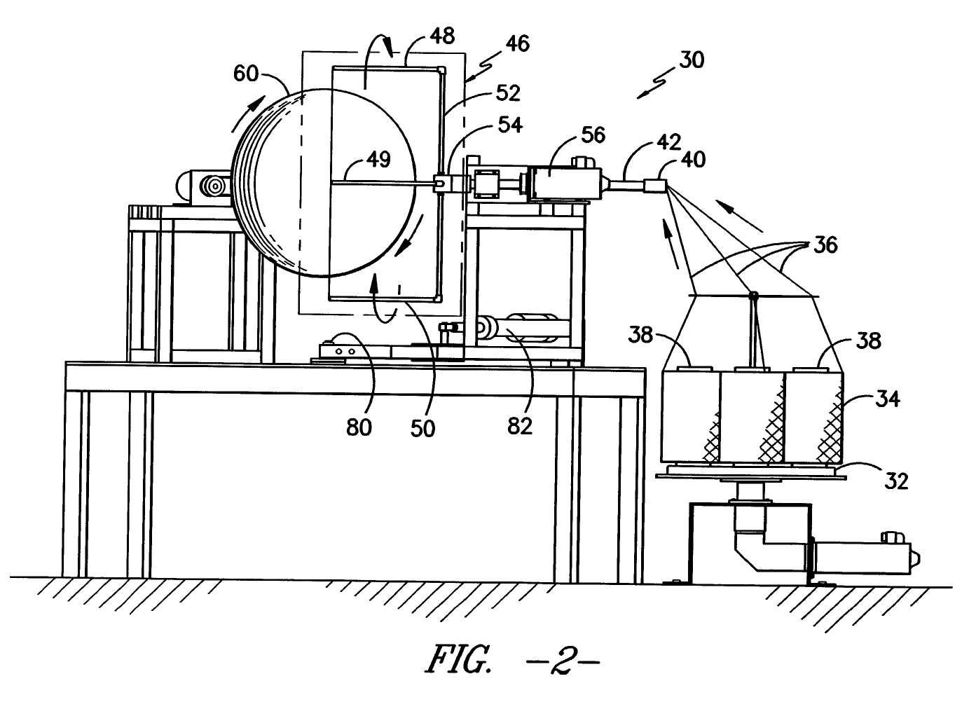

In FIG. 2 a side view of the apparatus 30 for carrying out the yarn winding operation according to the present invention is illustrated. As shown, the apparatus 30 preferably includes a rotatable platform 32 for holding one or more packages 34 of yarn 36 for use in formation of the airbag according to the present invention. The yarn 36 is preferably wrapped around a spool 38 such that the yarn may be removed in a continuous fashion without the occurrence of tangling. While multiple packages 34 are illustrated, it is to be understood that the present invention does not require the delivery of more than one continuous yarn 36 in order to achieve effective bag formation. When the operation is carried out with a single continuous yarn, the use of multiple packages has the advantage of avoiding frequent package replacement since the packages are already in place.

While the invention contemplates the use of a single yarn in the winding operation, it is likewise contemplated that two or more yarns 36 may be delivered and wrapped simultaneously in substantially side by side relation to one another during the winding operation. It is further contemplated that the yarns 36 and each of the packages 34 may be either of the same or of a different character. Thus, if an individual yarn 36 is to be wound according to the present invention the initial stages of the winding operation may be carried out using one type of yarn while the latter stages may be carried out using yarn of differing character. Likewise if two or more yarns 36 are to be wound simultaneously, it is contemplated that these yarns may be either of the same or differing character. As will be appreciated this ability to select combinations of yarns having different character may be of value in exploiting the benefits of various different yarn combinations within the structure to be formed.

In the illustrated and potential preferred practice, the yarn 36 is delivered to a central eye 40 for subsequent transmission through a tubular guide path 42 for eventual delivery through a balanced hollow arm rotating winding apparatus 46.

The winding apparatus 46 is preferably a symmetrical structure having at least two yarn delivery arms 48,50 extending outwardly from either end of an elongated support shaft the center of which preferably serves as the axis of rotation for the winding apparatus 46. As shown, the winding apparatus may also include one or more additional arms 49 preferably disposed in balanced relation to the other arms. In one potentially preferred embodiment, the winding apparatus will have four hollow symmetrically disposed yarn delivery arms each of which deliver a separate yarn 36 from a separate package 34.

In the preferred embodiment, the winding apparatus 46 is preferably rotated about the axis of rotation 54 by means of a variable speed motor 56 controlled by a computer (not shown) or other control means as are known to those of skill in the art such that the rate of winding and number of revolutions may be preset and closely monitored during the winding operation.

The yarn 36 which is delivered through the hollow winding apparatus to the end of at least one of the yarn delivery arms is initially secured in place against a collapsible mandrel 60 by either a small piece of adhesive tape or by manually wrapping one or two loops around the mandrel such that frictional forces prevent the yarn from pulling away. Thereafter, the mandrel 60 is rotated by means of its own independent variable speed motor 62 (FIG. 3) while simultaneously rotating the winding apparatus 46 such that the yarn 36 is continuously drawn from the supply package and wrapped by the winding apparatus around the mandrel. As will be appreciated, by controlling the rotation of both the mandrel 60 and the winding apparatus 46, substantial control can be exerted over the final yarn distribution.

The mandrel 60 is preferably covered at least in part by a release layer and/or a thin releasable film of a material such as PVC, polypropylene, polyamide, polyurethane, or the like to permit separation of the yarns 36 from the mandrel 60 following application of a permeability blocking coating layer as described below. In one particularly preferred embodiment, the releasable film is disposed across the surface of the mandrel 60 corresponding to the front of the cushion 14 against which the occupant 20 would be thrown, while the rear surface is wound without a release layer. This practice provides the dual advantage of minimizing the amount of release film utilized while at the same time providing an added barrier layer between the occupant and the inflation gases which are generally hot and may carry particulates.

As best illustrated in FIGS. 3-5, the mandrel 60 is preferably of a shape substantially corresponding to the final desired shape of the airbag cushion being formed. While any shape susceptible to rotation and yarn coverage may be utilized, it is contemplated that circular and ellipsoidal spheroids may be particularly preferred for driver's side airbag cushions.

The mandrel 60 itself is necessarily of such a nature that it can be removed from the final airbag structure after formation is complete. Materials which may be particularly well suited to this purpose include sculpted foam rubber, collapsible segmented metal structures, and durable textile structures formed from material such as KEVLAR®, or the like which may be held in an inflated state under modest gas pressures through connection to an air line during the processing sequence. As shown, the mandrel 60 is preferably connected to a hub 64 disposed along its axis of rotation. In the illustrated and potentially preferred practice, the placement and diameter of the hub 64 defines the location and size of the inlet port in the final airbag cushion.

As will be appreciated by those of skill in the art, the region surrounding the inlet port serves as the location of connection between the inflatable cushion 14 and the inflator 12 (FIG. 1A) and must, therefore, withstand significant stress during a deployment event. These stresses can be overcome by providing enhanced thickness of the cushion in this localized region.

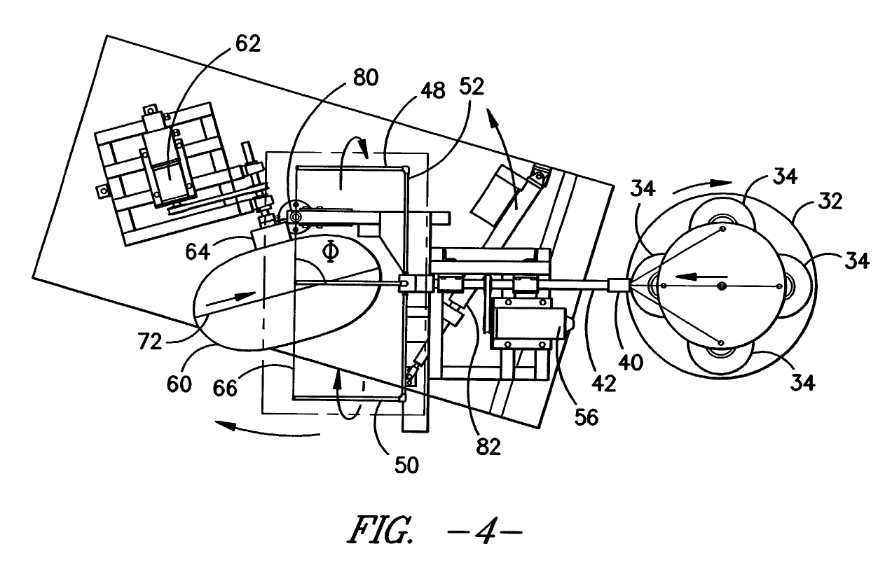

It has been found that by orienting the mandrel 60 relative to the winding apparatus 46 such that the yarn placement plane 66 (as defined by the outlet of the yarn delivery arms) runs immediately adjacent to the hub 64, that it is possible to obtain the desired increased thickness in the region surrounding the mouth at a distance therefrom with gradually decreasing yarn concentration as the distance from the mouth is increased. This preferential yarn concentration is illustrated in FIG. 6A wherein the gas inlet 70 disposed within the rear portion of the cushion 14 is surrounded by a relatively thick collar of material which decreases in concentration as the distance from the center is increased. That is, the number of yarns per unit area decreases as the perimeter of the cushion is approached.

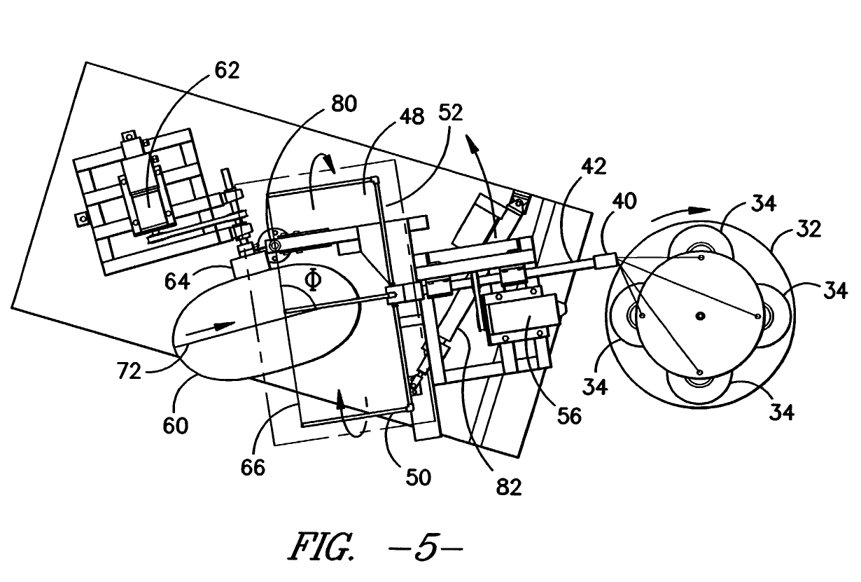

Aside from the desire to enhance the strength of the cushion in the area surrounding the inlet port 70, it is a further attribute of the cushion according to the present invention to avoid a preferential accumulation of yarns at the face of the inflatable cushion since such a build up gives rise to the formation of a generally undesirable hard nodule on the surface which is to be impacted by the vehicle occupant 20 during a collision event. It has been found that when the yarn 36 is wrapped around the rotating mandrel 60 while maintaining a fixed angle φ between the yarn placement plane 66 (FIG. 3) and the equatorial plane 72 of the mandrel, that each winding tends to cross over the prior windings within a relatively small localized location on the face of the inflatable cushion 14 which thereby causes the undesirable build- up of a thick nodule of yarn, 7, in this location on the face. Such a build-up of yarn is, of course, exactly what is desired in the region surrounding the inlet port 70 on the rear portion of the cushion 14 designated as Ro in FIG. 7.

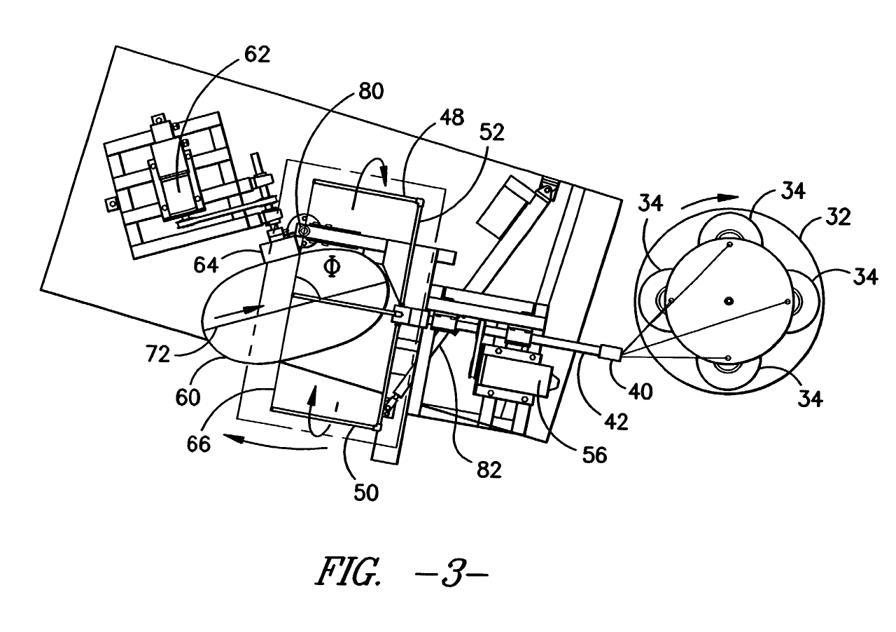

It has been found that these seemingly conflicting goals of concentrating the yarn around the inlet port on the rear of the cushion while at the same time spreading the yarn substantially evenly across the face may be achieved by systematically shifting or shogging the angle of the yarn placement plane 66 with respect to the equatorial plane 72 of the rotating mandrel 60 about a pivot point selected such that the yarn placement plane 66 continues to fall substantially adjacent to the hub 64 on the rear portion of the rotating mandrel 60. This systematic shifting of the yarn placement angle is best illustrated through reference to FIGS. 3-5, 6A and 7 wherein in FIG. 3 the yarn placement plane 66 is at a first angle φ with respect to the equatorial plane 72 of the mandrel. In FIGS. 4 and 5 this angle φ is gradually increased until the two planes are nearly perpendicular.

In the illustrated and potentially preferred practice of the present invention, shifting or shogging of the yarn placement plane is effected by pivoting the winding apparatus 46 about a pivot 80 (FIGS. 2-5) through use of an extensible and retractable power cylinder 82 acting on the support for the winding apparatus. In the illustrated and potentially preferred practice, the pivot 80 is placed such that its center is aligned just outside the outer perimeter of the hub 64 which serves to define the inlet port 70. As the power cylinder 82 is retracted from its fully extended position in FIG. 3 through an intermediate position in FIG. 4 to a fully retracted position in FIG. 5, the yarn placement on the front of the mandrel 60 is substantially changed. However, due to the selection of the pivot point location, the yarn placement on the rear of the mandrel is not significantly altered. Thus, the seemingly contradictory need to concentrate yarn around the inlet port while simultaneously spreading yarn across the face can be met. Moreover, since the power cylinder 82 may be cycled by the computer or other control means independently from the rotation of the mandrel and the winding apparatus, the pivoting action provides the operator with yet another degree of freedom with which to control the manufacturing process. It should be noted the maximum density build-up Rs occurs at a radius greater than the minimum radius of the hub Ro. See FIG. 7 wherein it is shown that the yarn density Rs is preferably located at a minimum radial distance from the hub opening of about 5% greater than the hub radius.

While it is contemplated that a wide variety of combinations of operating parameters may be utilized to produce inflatable restraint cushions according to the present invention, by way of example only, and not limitation, it is believed that in the preferred practice the mandrel 60 should be rotated at a rate of about 0.05 to about 30.0 revolutions per minute, the winding apparatus should be operated at a rate of about 50 to about 600 revolutions per minute, the angle φ between the yarn placement plane 66 and the equatorial plane 72 should be cycled between about 46° and about 90° with about 1 to about 20 full cycles of extension and retraction of the power cylinder 82 per minute.

While it is likewise contemplated that any number of different types of yarns 36 may be utilized, it is believed spun or filament polymeric yarns formed from fiber materials such as polyester, nylon 6, nylon 6.6, nylon 4.6, KEVLAR®, and SPECTRA® characterized by yarn linear densities in the range of about 40 to 1200 denier (preferably about 70 to 200 denier) and filament linear densities in the range of about 2 to 6 denier per filament (preferably 3 to 5 denier per filament) may be preferred. The average yarn concentration as measured by dividing the total mass of yarn utilized in a given bag by the surface area for that bag including regions of both low and high yarn concentration is preferably in the range of about 50 to 300 grams per m².

As will be appreciated, in some instances, the concentration of yarn itself may not be sufficient to block air flow. In addition, the release film which is carried with the cushion is preferably of a very light weight character and may not provide complete porosity blocking performance. Moreover such release films may be completely absent if the mandrel is of such a nature that a release layer is unnecessary. By way of example only, it is contemplated that a mandrel formed of a textile material coated with Teflon, silicone or other adhesion resistant material may make the use of a release layer unnecessary. Accordingly, in one potentially preferred practice, it is desirable to apply a porosity blocking coating of material across the wound yarn structure to hold the yarn in place and to provide containment for the gaseous inflation media generated during an expansion event. While any number of coating materials may be utilized, it is required that such material be flexible in nature such that it can span the voids between the yarns without failing under pressure. It is believed that thermoplastic or thermosetting compositions of polyurethane, polyamide, polypropylene, PVC, acrylics, and mixtures of these materials may be useful. These materials may be applied by spray coating, knife coating, dip coating or other commercial processes as may be known to those of skill in the art. By way of example only, it is believed that the weight concentration of the elastomer in the final bag may be in the range of about 40 to 900 grams perm.

As previously indicated, aside from a fundamental formation technique, the present invention further contemplates a potentially preferred shape for the inflatable cushion 14 so as to optimize the strength characteristics of the load bearing yarns 36 within the structure. Hence, this optimized shape characteristic would be used in the design of the mandrel 60 for use in the winding procedure described above.

It is believed that the maximum strength of a composite material such as the wound airbag structure of the present invention is obtained when the strains in the individual components are matched. Thus, the optimum shape for maximum strength in the airbag of the present invention is obtained when there is uniform tension in the yarns. It has been discovered that the shape which results in uniform tension in the yarns is a geometric curve which can be characterized parametrically in cylindrical coordinates for one quadrant by the equations

$$\frac{z}{a} = {\int }_{0}^{Θ} \frac{{( sin ( \frac{π}{2} - u ) )}^{( \frac{1}{2} )}}{2} ⅆ u$$

$$\frac{r}{a} = {( sin ( \frac{π}{2} - Θ ) )}^{\frac{1}{2}} 0 \leq Θ \leq \frac{π}{2}$$

Where r is the radical coordinate and z is the axial coordinate.

$$a = {[ \frac{V}{2 π {\int }_{0}^{\frac{π}{2}} sin ( \frac{x}{2} - Θ ) \frac{{( sin ( \frac{π}{2} - Θ ) )}^{( \frac{1}{2} )}}{2} ⅆ Θ} ]}^{\frac{1}{3}}$$

The radius at the equator is given by the equation: or approximately

$$a = .714 \cdot {V}^{\frac{1}{3}}$$

Where V is the desired volume of the bag at low inflation pressure.

The height to equatorial diameter (2a) ratio is:

$$\frac{2 \cdot h}{2 \cdot a} = {\int }_{0}^{\frac{π}{2}} \frac{{( sin ( \frac{π}{2} - u ) )}^{\frac{1}{2}}}{2} ⅆ u$$

or approximately:

$$\frac{2 \cdot h}{2 \cdot a} = .599$$

It is believed that the benefit of this shape in providing uniform yarn tension is achievable in substantial respect so long as the radial coordinate of the shape is within about plus or minus ten percent of its ideal value in relation to the other coordinates.

The film properties of one preferred film are as follows:

Thickness: .0013 inch

Peak Stress (machine direction): 5861 psi

Peak Stress (cross-machine direction,): 4174 psi.

Elongation at peak stress (machine direction): 298.0%

Elongation at peak stress (cross-machine direction): 393.0%

Energy-to-break (machine direction): 25.3 in-lb

Energy-to-break (cross-machine direction): 23.8 in-lb

The packing volume data of one embodiment of the present wound airbag cushion and a control sewn airbag cushion are as follows:

Test weight: 5 lb

Test chamber cross-section: 100mm ×150 mm

Control sewn bag

Packing height: 45 mm

Packing volume: 675 cm³

Wound bag (00221A, 601)

Packing height: 36 mm

Packing volume: 540 cm³

In accordance with one embodiment, the shogging angle, defined as the angle between the winding plane and the mandrel equatorial plane, varies from a minimum of 64.3 degrees to a maximum of 83.5 degrees. The yarns at the equator of the wound bags therefore lie at angles within this range.

With reference to FIGS. 8-12 of the drawings, the wound airbag or airbag cushion of the present invention may be formed by one of several different methods.

With reference to FIG. 8, the cushion is formed by winding yarn about a mandrel and then coating the yarn with an adhesive.

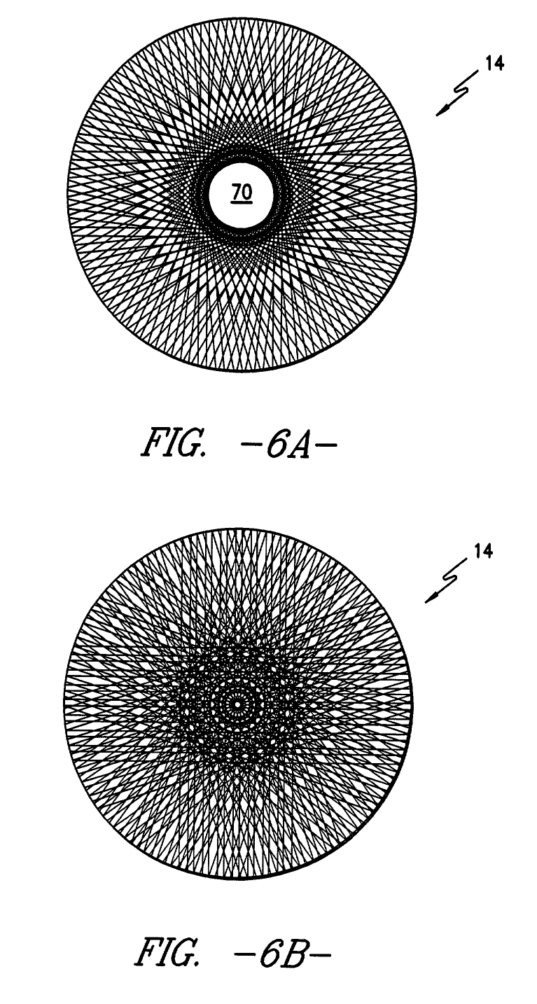

As shown in FIG. 9, the cushion is formed by wrapping the mandrel with a film, winding yarn about the film, and then coating the wound yarn with adhesive.

FIG. 10 illustrates an embodiment wherein the film is coated with an adhesive and then the yarn is wound thereon.

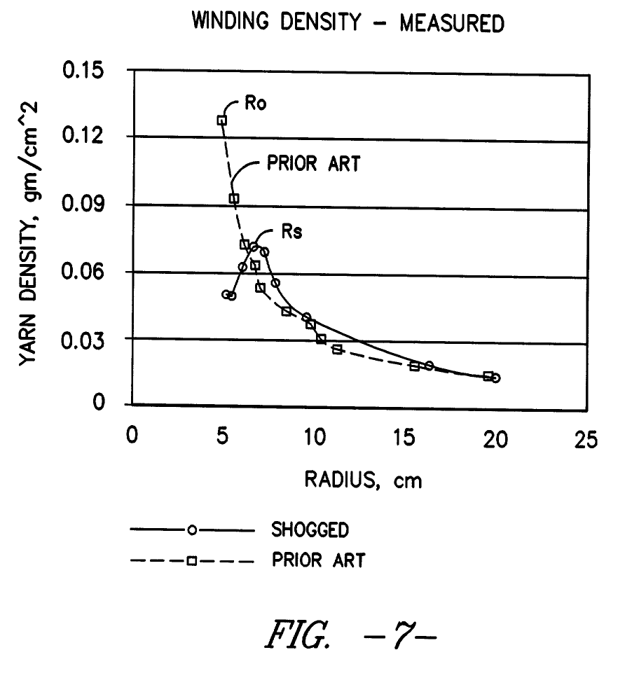

As shown in FIG. 11, the film is coated on its inner surface with an anti- blocking coating, release coating, burn-prevention coating, and/or the like.

With reference to FIG. 12, there is shown an embodiment with a second or outer layer or coating of adhesive, anti-blocking coating, release layer, and/or the like.

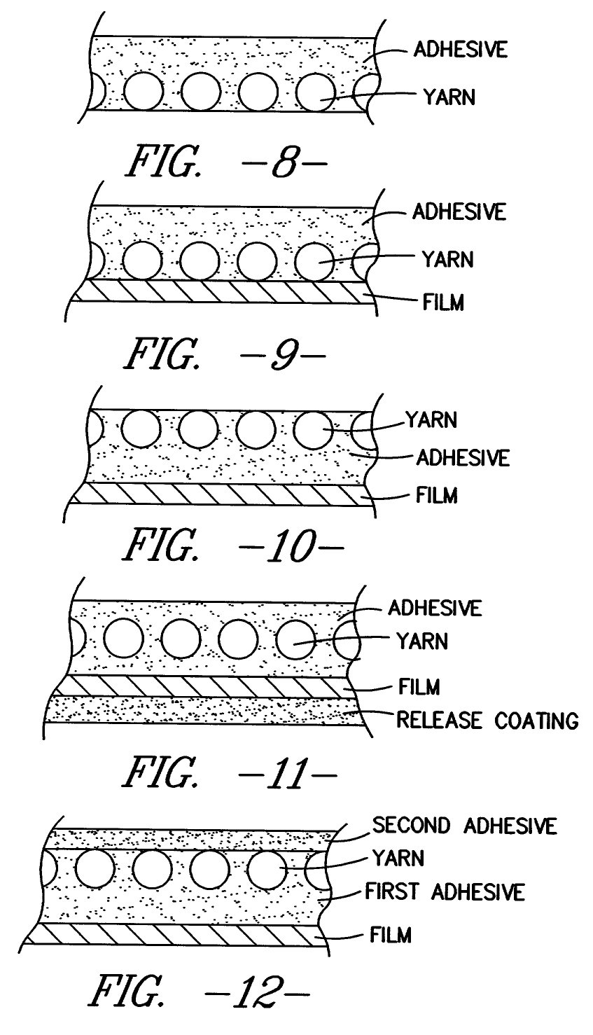

With reference to FIGS. 13-18 of the drawings, there is shown alternative bag or cushion structures.

FIG. 13 shows a wound airbag cushion 100 ready for attachment to an inflator.

FIG. 14 shows an airbag cushion 200 like cushion 100 with the addition of vent holes 210.

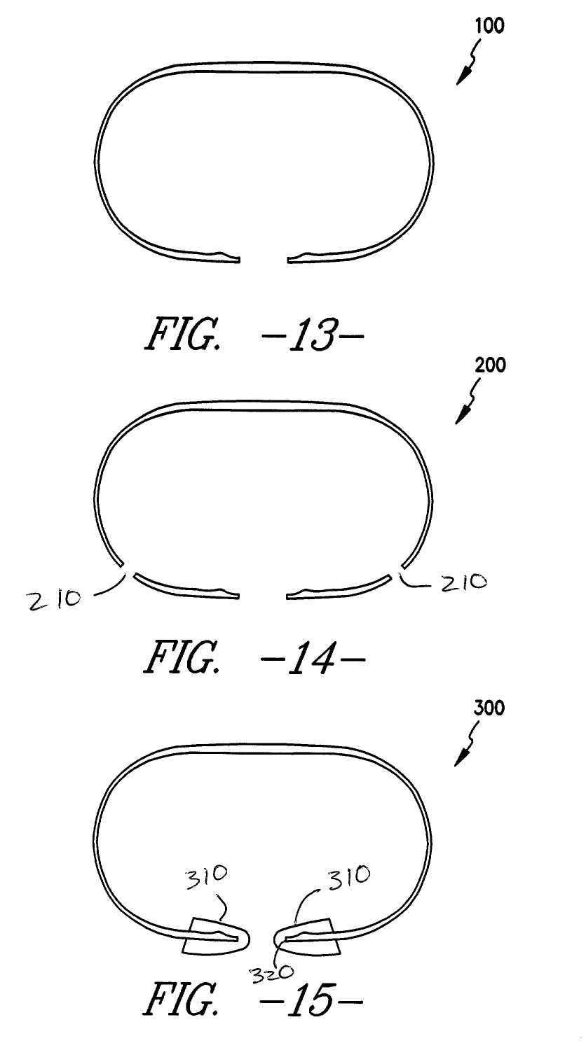

FIG. 15 depicts an airbag cushion 300 with a heat shield 310 attached to inlet 320.

FIG. 16 illustrates an airbag cushion 400 having tethers 410 attached to interior surfaces 420, 430 of front and back portions 440 and 450. Also, a reinforcement ring 460 is shown attached adjacent the inlet 480.

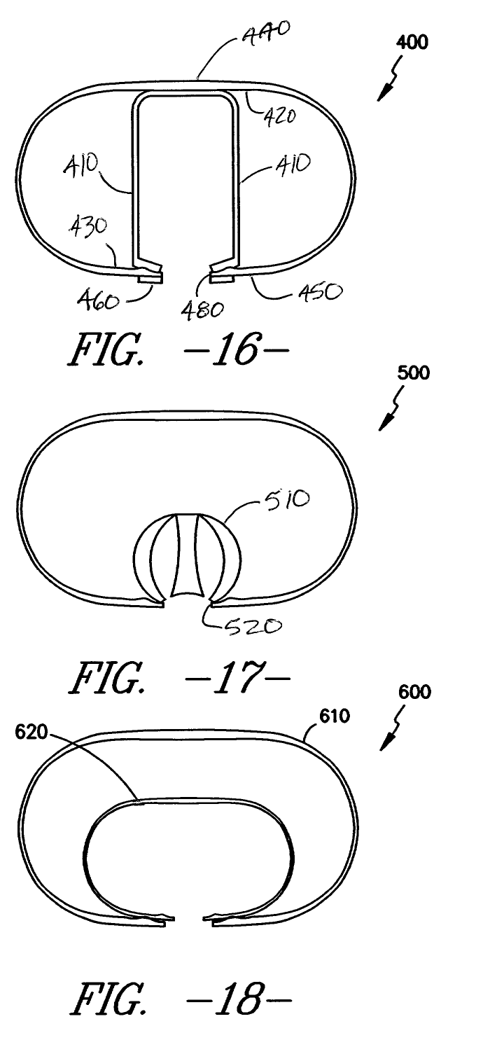

FIG. 17 represents a radial diffuser 510 attached about the inlet 520 of cushion 500.

FIG. 18 illustrates a bag in bag structure 600 having a smaller wound second bag 620 attached inside a larger outer wound bag 610.

Non-blocking or release agents include:

a. Dusting on the surface inorganic and certain organic powders, such as Talc, silica, sodium silicates, sodium aluminum silicates, calcium carbonate, aluminum oxide, starch, cellulose, Nylon6, PET, fluoropolymers, Nylon 6,6, and others that do not soften or melt at ~100 C.

b. Highly crosslinked polymeric materials that do not melt or soften at ~100 C. Examples are phenol formaldehyde resins, melamine formaldehyde resins, urea formaldehyde resins, epoxide resin, crosslinked silicones and blend of those highly crosslinking resins with other reactive resins, such as, polyacrylate, vinyl ester polymer, polyvinyl alcohol, polyurethane, polyesters, and the like.

c. Thermoplastic polymers with glass transition temperature or softening point well above 100 C., or highly crystalline polymers with melting point above 100 C. Examples are high density polyethylene, polyvinylidene fluoride and copolymer, polypropylene and the like.

Burn prevention or burn through proof materials include:

a. Thermosetting materials that do not melt and yet have relative good retention of physical properties at elevated temperature; examples are crosslinked silicones (dimethylsilioxane, diphenylsiloxanes, ...), and fluoropolymers (Teflon, polyvinylidene fluoride, ...), phenol formaldehyde polymers, etc.

b. Materials having good insulation properties and yet stable at high temperature - foamed, and highly filler polymers.

The following working examples are presented to provide a more complete understanding of the invention. The specific techniques, conditions, materials, and reported data should be understood to be exemplary only and should in no way be construed as in way limiting the scope of the invention which is intended to be defined and limited only by the full lawful scope of allowed claims and equivalents thereto.

### EXAMPLE I

An inflatable round spheroidal rotating mandrel formed of KEVLARO® reinforced nylon film having an equatorial diameter of 22 inches and a central depth of 11.75 inches was wrapped with a 1 mil thick film of PT9611 Polyurethane and inflated to a pressure of 1 psi and rotated at a rate of 0.322 revolutions per minute while a 112 denier multifilament yarn of polyester having a denier per filament rating of 3.4 was delivered by a winding arm at a rate of 240 revolutions per minute for a period of 15.5 minutes. During the winding operation, the angle between the plane of yarn placement and the equator of the mandrel was cycled from about 64.3 degrees to about 83.5 degrees and back every 0.134 minutes. The total mass of yarn delivered around the mandrel was 2.36 ounces over an area of 0.6836 square meters. An air line was used to maintain the mandrel in an inflated state during the winding operation. While still under inflation, the mandrel and yarns wrapped thereabout were coated with an aqueous base polyurethane composition. The dried add on weight of the coating composition was 63.4 grams for the entire structure. After drying, the sample was tested to failure by rapidly exposing it to air heated to 1000° F. A pressure of 19.4 psi was attained before the sample burst.

### EXAMPLE II

An inflatable spheroidal mandrel formed of KEVLAR® reinforced polyurethane film having an equatorial diameter of about 22.4 inches and a central depth of about 11.74 inches was wrapped with a 1.25 mil thick film of PT8010 polyurethane supplied by Deerfield Urethanes, Inc., weighing about 26 grams and then inflated to a pressure of 1.0 psi. The area of the inflated mandrel was 0.7536 square meters, and the ratio of central depth to the diameter was about 0.52. The mandrel was then rotated at a rate of 1.999 revolutions per minute while a 100 denier multifilament yarn of Nylon 6.6 supplied by the Akzo Corporation and having a denier per filament rating of 2.8 was wrapped therearound by a winding arm rotating at a rate of 200.005 revolutions per minute for a period of 19.5 minutes. During the winding operation, the angle between the plane of yarn placement and the equatorial plane of the mandrel was cycled from about 64 degrees to about 83 degrees and back every 0.134 minutes. The total mass of yarn wrapped around the mandrel was about 64 grams over an area of 0.7536 square meters, giving an average yarn density of about 85 grams per square meter. While still under inflation, the mandrel and yarn wound thereon were coated with a layer of adhesive solution consisting of 20 parts of RU40350 polyurethane emulsion manufactured by Stahl USA, and 80 parts of water. The amount of solution so applied weighed 260 grams. The mandrel, yarn, and adhesive, while still under inflation, were placed in an oven maintained at a temperature of 250 degrees Fahrenheit for a period of 1 hour. The cured add-on weight of the adhesive was 52 grams, giving an average adhesive density of about 69 grams per square meter. The mandrel was then deflated, allowing the sample to be removed therefrom. The total weight of the sample was measured to be 142 grams, giving an average density of material for the sample of about 188 grams per square meter. The sample was then mounted in suitable hardware, and rapidly inflated until the sample burst. The burst pressure and the time at which the burst occurred were recorded. The sample burst 17 milliseconds after the test began, and the recorded burst pressure was 22.8 pounds per square inch.

### EXAMPLE III

An inflatable spheroidal mandrel formed of KEVLAR® reinforced polyurethane film having an equatorial diameter of about 22.0 inches and a central depth of about 13 inches was wrapped with a 1.5 mil thick film of PT9611 polyurethane supplied by Deerfield Urethanes, Inc., weighing about 27 grams and then inflated to a pressure of 1.0 psi. The area of the inflated mandrel was 0.7604 square meters, and the ratio of central depth to the diameter was about 0.59. The mandrel was then rotated at a rate of 2.002 revolutions per minute while a 90 denier multifilament yarn of Nylon 6.6 supplied by the Sans Fibers Corporation and having a denier per filament rating of about 2.6 was wrapped therearound by a winding arm rotating at a rate of 199.0 revolutions per minute for a period of 22.5 minutes. During the winding operation, the angle between the plane of yarn placement and the equatorial plane of the mandrel was cycled from about 64 degrees to about 83 degrees and back every 0.208 minutes. The total mass of yarn wrapped around the mandrel was about 66 grams over an area of 0.7604 square meters, giving an average yarn density of about 87 grams per square meter. While still under inflation, the mandrel and yarn wound thereon were coated with a layer of adhesive solution consisting of 41 parts of Impranil 85UD polyurethane emulsion manufactured by Bayer Corporation, 15 parts of Rhoplex 3082 acrylic latex manufactured by Rhom & Haas Corporation, and 44 parts of water. The amount of solution so applied weighed 220 grams. After winding, the mandrel (while still inflated), yarn, and adhesive thereon were placed in an oven maintained at a temperature of 250 degrees Fahrenheit for a period of 30 minutes. The cured add-on weight of the adhesive was 55 grams, giving an average adhesive density of about 72 grams per square meter. The mandrel was then deflated, allowing the sample to be removed therefrom. The sample was then turned inside out and again placed on the mandrel, causing the polyurethane film to be on the outside, and the mandrel re-inflated. After re-inflation of the mandrel a mixture of equal parts of RP1519 silicone adhesive manufactured by Rhone- Poulenc Company and mineral spirits supplied by Aldrich Chemical Company was applied to the surface of the polyurethane film to prevent the film from adhering to itself, or “blocking”, when the inflatable restraint of the instant invention is folded and subjected to elevated temperatures as might be encountered in a vehicle sitting in direct sunlight for an extended period of time. The sample, while still inflated, was placed in an oven maintained at a temperature of 300 degrees Fahrenheit and cured for 30 minutes. The “antiblocking” coating, after curing, weighed about 16 grams. The mandrel was once again deflated, allowing the sample to be removed therefrom, and the sample was turned right side out. The total weight of the sample was measured to be 164 grams, giving an average density of material for the sample of about 216 grams per square meter. One pressure vent hole of 1.5 inch diameter was punched in the sample at a distance of about 10 inches from the center of the mouth of the sample. The restraint so made was then equipped with a 8 inch diameter silicone coated piece of 1 ounce per square yard material surrounding the inside of the throat opening to act as a heat shield, then folded and incorporated into a conventional automotive airbag module consisting of an inflator, cover, and ancillary hardware. The inflator at ambient temperature when used was capable of generating a maximum pressure of 210 kPa in a 60 liter rigid tank, and possessed a pressure rise rate of 50.0 kPa per 5 milliseconds. The sample was deployed by igniting the inflator and the deployed restraint was used to arrest the travel of an 80 pound weight travelling at approximately 18 miles per hour. The deployed restraint absorbed 79.4% of the kinetic energy of the weight, while sustaining no damage.

### EXAMPLE IV

An inflatable spheroidal mandrel formed of fiberglass reinforced nylon film having an equatorial diameter of about 21.4 inches and a central depth of about 12 inches was wrapped with a 1.3 mil thick film of DP1000 nylon supplied by Airtech, Inc., weighing about 18 grams and then inflated to a pressure of 1.5 psi. The area of the inflated mandrel was 0.7059 square meters, and the ratio of central depth to the diameter was about 0.56. The mandrel with film was then coated with 66 grams of adhesive solution consisting of a mixture of 10 parts of RP1519 silicone adhesive manufactured by Rhone-Poulenc Company and 68 parts of Mineral spirits supplied by Aldrich Chemical Company and 2 parts of DE83R flame retardant supplied by Great Lakes Chemical Company. The mandrel with film and adhesive was then placed in an oven maintained at 300 degrees Fahrenheit for a period of 5 minutes. The mandrel with film was then coated with 175 grams of adhesive solution consisting of mixture of 10 parts of RP1519 silicone adhesive manufactured by Rhone-Poulenc Company and 18 parts of Mineral spirits supplied by Aldrich Chemical Company and 2 parts of DE83R flame retardant supplied by Great Lakes Chemical Company. The mandrel was then rotated at a rate of 4.004 revolutions per minute while four separate 100 denier multifilament yarns of Nylon 6 supplied by the EMS Corporation and having a denier per filament rating of about 3.1 were wrapped therearound by a winding arm rotating at a rate of 199.0 revolutions per minute for a period of 6.0 minutes. During the winding operation, the angle between the plane of yarn placement and the equatorial plane of the mandrel was cycled from about 64 degrees to about 83 degrees and back every 0.208 minutes. The total mass of yarn wrapped around the mandrel was about 77 grams, giving an average yarn density of about 109 grams per square meter. After winding, the mandrel (while still inflated), yarn, and adhesive thereon were placed in an oven maintained at a temperature of 300 degrees Fahrenheit for a period of 20 minutes. The total cured add-on weight of adhesive was 78 grams, giving an average adhesive density of about 110 grams per square meter. The mandrel was then deflated, allowing the sample to be removed therefrom. The sample was then turned inside out and again placed on the mandrel, causing the nylon film to be on the outside, and the mandrel re-inflated. After re-inflation of the mandrel about 114 grams of a mixture of 10 parts of RP1519 silicone adhesive manufactured by Rhone-Poulenc Company and 18 parts of Mineral spirits supplied by Aldrich Chemical Company and 2 parts of DE83R flame retardant made by the Great Lakes Chemical Company was applied to the surface of the nylon film to give the sample increased resistance to burn through by the hot particles normally emitted by conventional airbag inflators. The sample, while still inflated, was placed in an oven maintained at a temperature of 300 degrees Fahrenheit, and cured for 10 minutes. The inside silicone coating, after curing, weighed about 46 grams. The mandrel was once again deflated, allowing the sample to be removed therefrom, and the sample was turned right side out. The total weight of the sample was measured to be about 217 grams, giving an average density of material for the sample of about 307 grams per square meter. Two pressure vent holes of 40 millimeter diameter were punched in the sample at a distance of about 5.6 inches from the center of the mouth of the sample. The restraint so made was then equipped with two 8 inch diameter silicone coated pieces of 1 ounce per square yard material surrounding the inside of the throat opening to act as a heat shield and throat reinforcement, in addition to a tether made from the same material and secured to the top of the sample by sewing. The sample was then folded and incorporated into a conventional automotive airbag module consisting of an inflator, cover, and ancillary hardware. The inflator when used at ambient temperature was capable of generating a pressure of 182 kPa in a 60 liter rigid tank, and possessed a pressure rise rate of 50.0 kPa per 5 milliseconds. The module was then put into a heat treatment chamber maintained at a temperature of 90 degrees Celsius and left for a period of 4 hours. After heat treatment, and before the assembly could cool, the sample was deployed by igniting the inflator and both the maximum and final excursion of the top of the sample were noted. For the sample, the maximum excursion was 17.5 inches and the final excursion was 12.25 inches. The “excess excursion” is the difference between the two, or 5.25 inches. The sample was undamaged by the deployment.

### EXAMPLE V

An inflatable spheroidal mandrel formed of fiberglass reinforced nylon film having an equatorial diameter of about 21.4 inches and a central depth of about 12 inches was wrapped with a 1.3 mil thick film of DP1000 nylon supplied by Airtech, Inc., weighing about 18 grams and then inflated to a pressure of 1.5 psi. The area of the inflated mandrel was 0.7059 square meters, and the ratio of central depth to the diameter was about 0.56. The mandrel with film was then coated with about 161 grams of adhesive solution consisting of mixture of 10 parts of RP1519 silicone adhesive manufactured by Rhone-Poulenc Company and 22 parts of Mineral spirits supplied by Aldrich Chemical Company and 2 parts of DE83R flame retardant supplied by Great Lakes Chemical Company. The mandrel was then rotated at a rate of 4.004 revolutions per minute while four separate 99 denier multifilament yarns of Nylon 6.6 supplied by the Akzo Corporation and having a denier per filament rating of about 3.0 were wrapped therearound by a winding arm rotating at a rate of 199.0 revolutions per minute for a period of 4.7 minutes. During the winding operation, the angle between the plane of yarn placement and the equatorial plane of the mandrel was cycled from about 64 degrees to about 83 degrees and back every 0.208 minutes. The total mass of yarn wrapped around the mandrel was about 61 grams, giving an average yarn density of about 86 grams per square meter. After winding, the mandrel (while still inflated), yarn, and adhesive thereon were placed in an oven maintained at a temperature of 300 degrees Fahrenheit for a period of 20 minutes. The cured add-on weight of the adhesive was about 57 grams, giving an average adhesive density of about 81 grams per square meter. The mandrel was then deflated, allowing the sample to be removed therefrom. The sample was then turned inside out and again placed on the mandrel, causing the nylon film to be on the outside, and the mandrel re-inflated. After re-inflation of the mandrel about 121 grams of a mixture of 10 parts of RP1519 silicone adhesive manufactured by Rhone-Poulenc Company and 22 parts of Mineral spirits supplied by Aldrich Chemical Company and 2 parts of DE83R flame retardant supplied by the Great Lakes Chemical Company was applied to the surface of the nylon film to give the sample increased resistance to burn through by the hot particles normally emitted by conventional airbag inflators. The sample, while still inflated, was placed in an oven maintained at a temperature of 300 degrees Fahrenheit, and cured for 10 minutes. The inside silicone coating, after curing, weighed about 42 grams. The mandrel was once again deflated, allowing the sample to be removed therefrom, and the sample was turned right side out. The total weight of the sample was measured to be 178 grams, giving an average density of material for the sample of about 252 grams per square meter. Two pressure vent holes of 40 millimeter diameter were punched in the sample at a distance of about 5.6 inches from the center of the mouth of the sample. The restraint so made was then equipped with a radial diffuser weighing 68 grams made of 840 denier ripstop Nylon 6.6 fabric. No tethers of any sort were used. The sample was then folded and incorporated into a conventional automotive airbag module consisting of an inflator, cover, and ancillary hardware. The inflator at ambient temperature when used was capable of generating a pressure of 182 kPa in a 60 liter rigid tank, and possessed a pressure rise rate of 50.0 kPa per 5 milliseconds. The module was then put into a heat treatment chamber maintained at a temperature of 90 degrees Celsius and left for a period of 4 hours. After heat treatment, and before the assembly could cool, the sample was deployed by igniting the inflator and both the maximum and final excursion of the top of the sample were noted. For the sample, the maximum excursion was 14.0 inches and the final excursion was 13.125 inches. The “excess excursion” is the difference between the two, or 0.875 inches.

### EXAMPLE VI

An inflatable spheroidal mandrel formed of fiberglass reinforced nylon film having an equatorial diameter of about 21.4 inches and a central depth of about 12 inches was wrapped with a 1.5 mil thick film of DP1000 nylon supplied by Airtech, Inc., weighing about 23 grams and then inflated to a pressure of 1.5 psi. The area of the inflated mandrel was 0.7059 square meters, and the ratio of central depth to the diameter was about 0.56. The mandrel with film was then coated with a layer of adhesive solution consisting of mixture of 10 parts of RP1519 silicone adhesive manufactured by Rhone-Poulenc Company and 22 parts of mineral spirits supplied by Aldrich Chemical Company and 2 parts of DE83R flame retardant supplied by Great Lakes Chemical Company. The amount of solution so applied weighed about 129 grams. The mandrel was then rotated at a rate of 4.004 revolutions per minute while four separate 110 denier multifilament yarns of Polyester supplied by the Kosa Corporation and having a denier per filament rating of about 3.3 were wrapped therearound by a winding arm rotating at a rate of 199.0 revolutions per minute for a period of 4.2 minutes. During the winding operation, the angle between the plane of yarn placement and the equatorial plane of the mandrel was cycled from about 64 degrees to about 83 degrees and back every 0.208 minutes. The total mass of yarn wrapped around the mandrel was about 60 grams, giving an average yarn density of about 85 grams per square meter. After winding, the mandrel (while still inflated), yarn, and adhesive thereon were placed in an oven maintained at a temperature of 300 degrees Fahrenheit for a period of 20 minutes. The cured add-on weight of the adhesive was about 45 grams, giving an average adhesive density of about 64 grams per square meter. The mandrel was then deflated, allowing the sample to be removed therefrom. The total weight of the sample was measured to be 128 grams, giving an average density of material for the sample of about 181 grams per square meter. To assess the effect of systematically varying the angle between the plane of yarn placement and the equatorial plane of the mandrel, samples were extracted from the bag at various radii from the central axis of symmetry of the sample. The maximum local density of material was found to be 720 grams per square meter at a radius of 6.7 centimeters from the axis of symmetry. The local density of material at a radius of 5.2 centimeters (the minimum radius achievable at the throat of the bag) was found to be 499 grams per square meter. The local density of material at the top of the bag at the axis of symmetry was found to be 679 grams per square meter.

### EXAMPLE VII

An inflatable spheroidal mandrel formed of fiberglass reinforced nylon film having a nominal volume of 52 liters and an equatorial diameter of about 21.4 inches and a central depth of about 12 inches was wrapped with a 1.5 mil thick film of DP1000 nylon supplied by Airtech, Inc., weighing about 23 grams and then inflated to a pressure of 1.5 psi. The area of the inflated mandrel was 0.7059 square meters, and the ratio of central depth to the diameter was about 0.56. The mandrel with film was then coated with a layer of adhesive solution consisting of mixture of 3.5 parts of RP1519 silicone adhesive manufactured by Rhone-Poulenc Company and 6.5 parts of Mineral spirits supplied by Aldrich Chemical Company. The amount of solution so applied weighed about 129 grams. The mandrel is then rotated at a rate of 4.004 revolutions per minute while two separate 100 denier multifilament yarns of Polyester supplied by the Kosa Corporation and having a denier per filament rating of about 3.3 and two separated 100 denier multifilament yarns of Nylon 6,6 supplied by the Akzo Corporation and having a denier per filament rating of 2.8 are wrapped therearound by a winding arm rotating at a rate of 199.0 revolutions per minute for a period of 4.2 minutes. During the winding operation, the angle between the plane of yarn placement and the equatorial plane of the mandrel is cycled from about 64 degrees to about 83 degrees and back every 0.208 minutes. The total mass of yarn wrapped around the mandrel is about 60 grams, giving an average yarn density of about 85 grams per square meter. After winding, the mandrel (while still inflated), yarn, and adhesive thereon are placed in an oven maintained at a temperature of 300 degrees Fahrenheit for a period of 20 minutes. The cured add-on weight of the adhesive is about 45 grams, giving an average adhesive density of about 64 grams per square meter. The mandrel is then deflated, allowing the sample to be removed therefrom. The total weight of the sample is measured to be 128 grams, consisting of equal amounts of Polyester yarn and Nylon 6,6 yarn. The total average density of material for the sample is about 181 grams per square meter. One pressure vent hole of 1.5 inch diameter is punched in the sample at a distance of about 10 inches from the center of the mouth of the sample. The restraint so made is then equipped with a 8 inch diameter silicone coated piece of 1 ounce per square yard material surrounding the inside of the throat opening to act as a heat shield, then folded and incorporated into a conventional automotive airbag module consisting of an inflator, cover, and ancillary hardware. The inflator at ambient temperature when used is capable of generating a maximum pressure of 210 kPa in a 60 liter rigid tank, and possesses a pressure rise rate of 50.0 kPa per 5 milliseconds. The sample is deployed by igniting the inflator and the deployed restraint is used to arrest the travel of an 80 pound weight travelling at approximately 18 miles per hour. No damage to the restraint is evident.

### EXAMPLE VIII

An inflatable spheroidal mandrel formed of fiberglass reinforced nylon film having a nominal volume of 52 liters and having an equatorial diameter of about 21.4 inches and a central depth of about 12 inches was wrapped with a 1.5 mil thick film of DP1000 nylon supplied by Airtech, Inc., weighing about 23 grams and then inflated to a pressure of 1.5 psi. The area of the inflated mandrel was 0.7059 square meters, and the ratio of central depth to the diameter was about 0.56. The mandrel with film was then coated with a layer of adhesive solution consisting of mixture of 3.5 parts of RP1519 silicone adhesive manufactured by Rhone-Poulenc Company and 6.5 parts of Mineral spirits supplied by Aldrich Chemical Company. The amount of solution so applied weighed about 129 grams. The mandrel is then rotated at a rate of 4.004 revolutions per minute while four separate 100 denier multifilament yarns of Nylon 6,6 supplied by the Akzo Corporation and having a denier per filament rating of 2.8 are wrapped therearound by a winding arm rotating at a rate of 199.0 revolutions per minute for a period of 1.7 minutes. During the winding operation, the angle between the plane of yarn placement and the equatorial plane of the mandrel is cycled from about 64 degrees to about 83 degrees and back every 0.208 minutes. The total mass of yarn wrapped around the mandrel is about 22.5 grams, giving an average yarn density of about 31.9 grams per square meter. After winding, the mandrel (while still inflated), yarn, and adhesive thereon are placed in an oven maintained at a temperature of 300 degrees Fahrenheit for a period of 20 minutes. The cured add-on weight of the adhesive is about 45 grams, giving an average adhesive density of about 64 grams per square meter. The mandrel is then deflated, allowing the sample to be removed therefrom. The total weight of the sample is measured to be 90.5 grams giving an average density of material for the sample of about 128 grams per square meter. The restraint so made is then attached to a device capable of generating pressure within said restraint for the purposes of assessing the burst pressure. The burst pressure of the restraint made as herein described is measured to be 10.0 pounds per square inch.

### EXAMPLE IX

An inflatable spheroidal mandrel formed of fiberglass reinforced nylon film having a nominal volume of 52 liters and having an equatorial diameter of about 21.4 inches and a central depth of about 12 inches was wrapped with a 1.5 mil thick film of DP1000 nylon supplied by Airtech, Inc., weighing about 23 grams and then inflated to a pressure of 1.5 psi. The area of the inflated mandrel was 0.7059 square meters, and the ratio of central depth to the diameter was about 0.56. The mandrel with film was then coated with a layer of adhesive solution consisting of mixture of 3.5 parts of RP1519 silicone adhesive manufactured by Rhone-Poulenc Company and 6.5 parts of Mineral spirits supplied by Aldrich Chemical Company. The amount of solution so applied weighed about 129 grams. The mandrel is then rotated at a rate of 4.004 revolutions per minute while four separate 100 denier multifilament yarns of Nylon 6,6 supplied by the Akzo Corporation and having a denier per filament rating of 2.8 are wrapped therearound by a winding arm rotating at a rate of 199.0 revolutions per minute for a period of 5.2 minutes. During the winding operation, the angle between the plane of yarn placement and the equatorial plane of the mandrel is cycled from about 64 degrees to about 83 degrees and back every 0.208 minutes. The total mass of yarn wrapped around the mandrel is about 67.5 grams, giving an average yarn density of about 95.6 grams per square meter. After winding, the mandrel (while still inflated), yarn, and adhesive thereon are placed in an oven maintained at a temperature of 300 degrees Fahrenheit for a period of 20 minutes. The cured add-on weight of the adhesive is about 45 grams, giving an average adhesive density of about 64 grams per square meter. The mandrel is then deflated, allowing the sample to be removed therefrom. The total weight of the sample is measured to be 135.5 grams giving an average density of material for the sample of about 192 grams per square meter. The restraint so made is then attached to a device capable of generating pressure within said restraint for the purposes of assessing the burst pressure. The burst pressure of the restraint made as herein described is measured to be 30.0 pounds per square inch.

In accordance with one embodiment of the present invention, inflatable restraints are made as follows:

(1) A formed film structure, made of film which (a) is impervious to the flow of fluid;

(b) possesses a shape which, when inflated at a low pressure, approximates that of an oblate spheroid; and

(c) possesses a reinforced cutout area reinforced by a substantially non-stretchable material which is adhesively attached thereto.

(2) An inflatable mandrel having novel vent means, is covered by the film structure described in (1) above, and if not vented when inflated, it is possible for air to be trapped between the outer surface of the mandrel and the inside surface of the film. The novel venting means consists of an open channel from the topmost part of the mandrel (i.e., the locus of the mandrel surface and the axis of symmetry opposite the point from which the mandrel is held) through the center of the axial support rod of the mandrel and into the base of the mandrel. The channel continues therethrough taking a path which avoids the channel used for inflating the mandrel, terminating with an opening to the outside air.

The mandrel itself is of oblate spheroid shape and consists of an internal impervious plastic film around which is wrapped a multifilament yarn, and an adhesive matrix to bind the two together. The yarn is wound in such a way as to get a uniform circumferential distribution by rotating the spheroidally shaped film about the minor axis of said spheroid during the winding. The angle between the yarn axis and the equatorial plane of said spheroid varies between about 64 and about 83 degrees.

(3) A winding apparatus having a carousel-type yarn supply creel is capable of holding more than one yarn supply bobbin containing reinforcing yarn which is to be wrapped around the mandrel in the process of making the inflatable restraint. When an inflatable restraint is made according to the present invention, yarn is wrapped around the mandrel which supports the film structure (described above in (2) and (1) respectively) by a rotating wrapping device. With the carousel yarn supply creel of the present invention, turning in synchronization with the wrapping device, multiple yarns can be wound simultaneously from multiple supply packages without becoming twisted around one another, decreasing the time necessary to wrap a desired amount of reinforcing yarn.

In accordance with at least one aspect of the present invention, a strong lightweight airbag cushion for deployment in opposing relation to a vehicle occupant during a collision event includes a body of wound yarn including an interior, a face portion for contact with the vehicle occupant and a rear portion including an inlet port for the introduction of an inflation medium into the body, wherein the body is formed by windings of yarn such that the yarn is spread across said face portion of said body and such that the yarn is disposed preferentially across the back of said body in the area surrounding the inlet port so as to form a localized region of enhanced thickness around at a predetermined distance from the inlet.

The airbag cushion as set forth above, wherein the body includes a flexible permeability blocking coating of material.

The airbag cushion as set forth above, wherein flexible permeability blocking coating of material is an elastomeric adhesive.

The airbag cushion as set forth above, wherein the elastomeric adhesive is applied across the surface of said cushion in the form of a curable dispersion subsequent to the winding of the yarn around the mandrel.

The airbag cushion as set forth above, further including a film disposed across at least a portion of the interior of said body.

The airbag cushion as set forth above, wherein the windings comprise one yarn.

The airbag cushion as set forth above, wherein the one yarn is a yarn formed from polymeric materials selected from the group consisting of polyester, Nylon 6, Nylon 6.6, Nylon 4.6 and blends thereof.

The airbag cushion as set forth above, wherein the one yarn has a linear density in the range of about 40 to 400 denier.

In accordance with at least one aspect of the present invention, a strong lightweight, inflatable airbag cushion for deployment in opposing relation to a vehicle occupant during a collision event includes a body including an interior, a face portion for contact with the vehicle occupant and a rear portion including an inlet port for introduction of an inflation medium into the body, wherein the body is formed by substantially continuous windings of yarn disposed around a rotating collapsible mandrel of a shape substantially corresponding to the final desired shape of the airbag cushion, while systematically shifting the angle of placement of the yarn with respect to the equatorial plane of said mandrel such that the yarn is spread across said face.

The airbag cushion as set forth above, having a round spheroidal shape wherein the ratio of depth to equatorial diameter is about 0.5 to 0.7.

The airbag cushion as set forth above, further including a flexible, permeability blocking coating layer of elastomeric adhesive holding the yarn in place.

The airbag cushion as set forth above, wherein the elastomeric adhesive is applied across the surface of said cushion in the form of a curable dispersion subsequent to the substantially continuous winding of yarn around said rotating mandrel.

The airbag cushion as set forth above, including a film disposed across at least a portion of the interior of said body.

The airbag cushion as set forth above, wherein the windings comprise one yarn.

The airbag cushion as set forth above, wherein the one yarn is a yarn formed from polymeric materials selected from the group consisting of polyester, Nylon 6, Nylon 6.6, Nylon 4.6 and blends thereof.

The airbag cushion as set forth above, wherein said one yarn has a linear density in the range of about 40 to 400 denier.

While specific preferred embodiments and materials have been illustrated, described and identified, it is to be understood that the invention is in no way limited thereto since modifications may be made and other embodiments of the invention will occur to those of skill in the art to which this invention pertains. Thus, it is intended to cover any such modifications and other embodiments ads incorporated the features of this invention within the full lawful scope of the allowed claims as follows.

What is claimed is:

1. A strong lightweight airbag cushion for deployment in opposing relation to a vehicle occupant during a collision event, the cushion comprising:
a body including an interior, a face portion for contact with the vehicle occupant and a rear portion including an inlet port for the introduction of an inflation medium into the body, wherein the body is formed by windings of yarn such that the yarn is spread across said face portion of said body and such that the yarn is disposed preferentially across the back of said body in the area surrounding the inlet port and an adhesive coating on at least one of the interior and exterior of said windings.

2. The cushion of claim 1 wherein said body further includes at least one film layer on the interior thereof.

3. The airbag cushion according to claim 1, wherein said adhesive coating is at least one flexible permeability blocking coating material.

4. The airbag cushion according to claim 3, wherein said flexible permeability blocking coating material is an elastomeric adhesive.

5. The airbag cushion according to claim 4, wherein said elastomeric adhesive is applied across the surface of said cushion in the form of a curable dispersion subsequent to the winding of said yarn around said mandrel.

6. The airbag cushion according to claim 4, wherein said elastomeric adhesive is applied across the surface of said cushion in the form of a curable dispersion prior to the winding of said yarn around said mandrel.

7. The airbag cushion according to claim 1, further comprising a film disposed across at least a portion of the interior of said body.

8. The airbag cushion according to claim 1, wherein said windings comprise at least one yarn.

9. The airbag cushion according to claim 8, wherein said one yarn is a yarn formed from polymeric materials selected from the group consisting of polyester, Nylon 6, Nylon 6.6 Nylon 4.6 and blends thereof.

10. The airbag cushion according to claim 8, wherein said one yarn has a linear density in the range of about 40 to 400 denier.

11. The airbag cushion according to claim 1, having at least one of a round spheroidal and ellipsoidal shape.

12. The airbag cushion according to claim 1, further including at least one of an anti-blocking, release, and burn prevention material on the interior of said body.

13. The airbag cushion according to claim 12, wherein said at least one anti-blocking release, and burn prevention material is applied across the inner surface of said cushion in the form of a curable dispersion subsequent to the substantially continuous winding of yarn.

14. The airbag cushion according to claim 13, wherein said material is disposed across the entire interior of said body.

15. The airbag cushion according to claim 1, further including at least one of an anti-blocking, release, and burn prevention material on the exterior of said body.

16. The airbag cushion according to claim 12, wherein said film is at least one of PVC, polypropylene, polyamide, and polyurethane.

17. The airbag cushion of claim 1 wherein the cushion has at least one of a round ellipsoidal and spheroidal shape wherein the ratio of depth to equatorial diameter is about 0.5 to 0.7.

18. A process of manufacturing a strong lightweight airbag cushion comprising the steps of: providing an inflated spheroidal rotating mandrel having a rotating collar, winding yarn from a rotating arm onto said mandrel and varying back and forth the angle between the plane of yarn placement and the equatorial of the mandrel to provide an area of enhanced yarn density at a non-zero distance away from the rotating collar, and coating at least one of said mandrel and wound yarn with an adhesive coating.

19. The process of claim 18 wherein said angle is varied between about 46° and 90°.

20. The process of claim 19 wherein said coating material is applied to the mandrel prior to winding said yarn.

21. The process of 18 wherein said coating material is applied to said wound yarn.

22. The process of claim 18 further comprising the step of covering said mandrel with at least one film prior to said winding and coating steps.

23. A strong lightweight airbag cushion for deployment in opposing relation to a vehicle occupant during a collision event, the cushion comprising:
a body including an interior, a face portion for contact with the vehicle occupant and a rear portion including an inlet port for the introduction of an inflation medium into the body, wherein the body is formed by windings of yarn such that the yarn is spread across said face portion of said body and such that the yarn is disposed preferentially across the back of said body in the area surrounding the inlet port, wherein the angle between a winding plane and mandrel equatorial plane varies from about 46 to about 90 degrees.

24. The cushion according to claim 23, wherein said body includes a flexible permeability blocking layer.

25. The airbag cushion according to claim 24, wherein said flexible permeability blocking layer is at least one of a film and a coating of material.

26. The airbag cushion according to claim 24, further comprising a film disposed across at least a portion of the interior of said body.

27. The airbag cushion according to claim 23, wherein a pivot point for the winding plane is located a short distance away from said inlet port.

28. A strong lightweight airbag cushion for deployment in opposing relation to a vehicle occupant during a collision event, the cushion comprising:
a body including an interior, a face portion for contact with the vehicle occupant and a rear portion including an inlet port for the introduction of an inflation medium into the body, wherein the body is formed by substantially continuous windings of yarn in a shape substantially corresponding to the final desired shape of the airbag cushion, with the angle of placement of the yarn with respect to an equatorial plane of said body shifted from about 64 to about 84 degrees such that the yarn is spread across said face.

29. The airbag cushion according to claim 28, having a round spheroidal shape wherein the ratio of depth to equatorial diameter is about 0.5 to 0.7.

30. The airbag cushion according to claim 28, further including a flexible, permeability blocking coating layer of elastomeric adhesive holding the yarn in place.

31. The airbag cushion according to claim 30, further comprising a film disposed across at least a portion of the interior of said body.

32. A strong lightweight airbag cushion for deployment in opposing relation to a vehicle occupant during a collision event, the cushion comprising: a body including an interior, a face portion for contact with the vehicle occupant and a rear portion including an inlet port for the introduction of an inflation medium into the body, wherein the body is formed by a film layer, windings of yarn such that the yarn is spread across said face portion of said body and such that the yarn is disposed preferentially across the back of said body in the area surrounding the inlet port, and a flexible permeability blocking coating of material.

33. The airbag cushion according to claim 32, wherein said coating is applied across the surface of said cushion in the form of a curable dispersion at least one of prior to and subsequent to the winding of said yarn around said film.

34. The airbag cushion according to claim 32, wherein said film is a thin releasable film.

35. The airbag cushion according to claim 34, wherein said film is at least one of PVC, polypropylene, polyamide, and polyurethane.

36. A process of manufacturing a strong lightweight airbag cushion comprising the steps of: providing a removable rotating mandrel having a rotating collar, wrapping at least one film over said mandrel, coating said film with at least one adhesive material, supplying yarn from a rotating arm onto said coated film on said mandrel and varying back and forth the angle between the plane of yarn placement and the equatorial of the mandrel to provide an area of enhanced yarn density at a non-zero distance away from the rotating collar, curing said adhesive to form a cured bag, and removing said mandrel from said bag.

37. The process of claim 36 wherein said angle was varied between 46° and 90°.

38. The process of claim 36, further including the step of coating at least one of the interior and exterior of said cured bag with at least one of an anti-blocking, release, and burn prevention material.

39. The process of claim 36 further including the step of creating at least one vent opening in said cured bag.

40. The process of claim 36, further including the step of adding at least one of a tether, diffuser, and heat shield to said cured bag.

41. The process of claim 36 further including the step of adding at least one smaller wound bag to the interior of said cured bag.

42. The cushion of claim 2, wherein said film has a thickness of at least 0.001 inches, a peak stress of at least 4000 psi, an elongation at peak stress of at least 290%, and an energy-to-break of at least 20 in-lb.

43. The cushion of claim 33, wherein the cushion has a weight of less than 6 lbs., a packing height of less than 35 mm, and a packing volume of less than 550cm³.

44. The cushion of claim 33, wherein the maximum density of yarn is less than about 750 grams per square meter.

45. The cushion of claim 33, wherein the burst strength is at least 20 psi.

46. The cushion of claim 33, wherein the maximum excess excursion is less than 6 inches.

47. The cushion of claim 33, wherein said film is nylon.

48. The cushion of claim 33, having a burst pressure of at least 20 pounds per square inch and a weight of less than 200 grams.

49. The cushion of claim 33, wherein said cushion is substantially air impervious.

50. The cushion of claim 1, having less than the maximum number of yarns at the center of the face thereof.

51. The cushion of claim 33, having an average yarn density less than 150 grams per square meter.

52. An airbag cushion produced by the process of claim 18.

53. An airbag cushion produced by the process of claim 36.

54. The airbag cushion of claim 32, further including at least one of a diffuser, tether, heat shield, vent opening, interior bag, and combinations thereof.

55. The airbag cushion of claim 54, wherein a porosity blocking coating is applied over any seams.

56. The airbag cushion of claim 8, wherein one yarn is a high stretch yarn and a second yarn is a low stretch yarn.

57. A wound airbag cushion, having zero air permeability, a burst pressure of about 10-30 psi, and an average yarn density of less than about 250 grams per square meter.

58. The airbag cushion of claim 57, wherein said average yarn density is less than about 150 grams per square meter.

59. In a vehicle restraint system, the improvement comprising the airbag cushion of claim 32.

60. In an airbag module, the improvement comprising the airbag cushion of claim 32.
